(19) United States
(12) Patent Application Publication
(10) Pub. No.: US 2013/0282521 A1
(43) Pub. Date: Oct. 24, 2013

(54) PUBLISHING, LICENSING, DISTRIBUTING AND/OR CONSUMING EDUCATION E-CONTENT

(71) Applicants: Sharad K. Garg, Portland, OR (US); Lihui C. Tung, Portland, OR (US)

(72) Inventors: Sharad K. Garg, Portland, OR (US); Lihui C. Tung, Portland, OR (US)

(21) Appl. No.: 13/995,486

(22) PCT Filed: Aug. 29, 2011
(86) PCT No.: PCT/US2011/049526

§ 371 Date: Jun. 18, 2013

(51) Int. Cl. G06Q 30/06

(52) U.S. Cl. CPC G06Q 30/0633
USPC 705/26.8

(57) ABSTRACT

Disclosed herein are systems, methods and storage medium associated with publication, licensing, distribution and/or consumption of education e-content. In various embodiments, a method may include receiving, by a license server, from a publisher server associated with one of a number of unassociated publishers meta-data associated with an education e-content published by the one publisher. The license server may be configured to serve the unassociated publishers. Further, the method may include receiving, by the license server, an order for the education e-content including consumption device related information that at least facilitates identification of one or more consumption devices to receive the educational e-content. The method may include generating, by the license server, a license including the meta-data and the consumption device related information for use by a content server to distribute the education e-content to one or more consumption devices to fill the order, and transmitting, by the license server, to the content server, the license. Other embodiments may be disclosed or claimed.

### TECHNICAL FIELD

Embodiments relate to the fields of data processing, in particular, to systems, methods and storage medium associated with publishing, licensing, distributing and/or consuming education e-content.

### BACKGROUND

Unless otherwise indicated herein, the materials described in this section are not prior art to the claims in this application and are not admitted to be prior art by inclusion in this section.

With advances in integrated circuit, computing and networking technologies, publication, distribution and consumption of education content are also undergoing technological changes. For example, K-8 education system in developing countries is going through many advancement and technological changes, with the aim of providing personalized learning for children. Several major education books/content publishers are now providing education e-content for the K-8 education market. Similar developments are also occurring in Grade 9-12 and College level education. The developments are also not limited to developing countries only, but occurring in developed countries as well. In the case of developed countries, similar developments are also occurring for Continuing Education. These markets are different from conventional B2C (Business to Consumer) commerce sites such as Amazon or any existing app store. For these markets, students typically do not purchase educational content directly from publishers or their agents/distributors; instead a teacher, a school, school district, university system or professional organization administrator, or a country's Ministry of Education (MoE) officials will purchase an educational e-content for a specific grade for an entire School, University, School District, University System, or Professional Organization, as the case may be. A MoE may, for example, decide to buy Grade 3 Math e-content from Publisher Acme for all Grade 3 students. These scenarios may be referred to as B2G (Business to Government) or B2E (Business to Entity) commerce. Additionally, instead of buying the educational e-content, the e-content may be rented by above mentioned customers (teachers, administrators or country's Ministry of Education (MoE) officials) for a specific period of time.

For the B2G and B2E markets, publishers would like to make sure that their educational e-contents are distributed only on authorized machines, in compliance with the number of licenses purchased/rented, and business rules of the publishers. E.g., if an educational e-content is targeted for grade 4 science students, then it should not be distributed to grade 5 students. In addition, publishers would like to distribute their educational e-content securely onto a student's computing platform, making sure that the content is not tampered with, and prevent unauthorized copies after the content has been distributed onto the students' computing platforms. Publishers also would like to make sure that after the expiry of license, the content should be unusable on students' computing platforms.

### BRIEF DESCRIPTION OF THE DRAWING

Embodiments of the present disclosure will be presented by way of exemplary embodiments, but not limitations, illustrated in the accompanying drawings in which like references denote similar elements, and in which:

FIG. 1 illustrates an overview of an arrangement for publishing, licensing, distributing and/or consuming education e-content;

FIG. 2 illustrates a publishing method;

FIG. 3 illustrates a licensing method;

FIG. 4 illustrates a distribution method;

FIG. 5 illustrates a consumption method;

FIG. 6 illustrate a non-transitory computer-storage medium configured to enable a computing device to practice one of the above illustrated methods; and

FIG. 7 illustrates an example computer system suitable for use as a publisher server, a license server, a content server, or a consumption device, where all of the foregoing illustrations are arranged in accordance with embodiments of the present disclosure.

### DETAILED DESCRIPTION

Embodiments of systems, methods and storage medium are associated with publishing, licensing, distributing, and/or consuming education e-content. In various embodiments, an apparatus for publishing education e-content may include an encryption module configured to be operated by a processor to generate an encrypted version of an education e-content of one of a number of unassociated publishers. The encrypted version of the education e-content may be distributed to consumption devices through a content server configured to serve the unassociated publishers. The apparatus may further include a publishing module configured to be operated by a processor to publish the education e-content. Publishing the education e-content may include transmission of meta-data associated with the educational e-content to a license server configured to serve the publishers. The meta-data may be used by the license server to generate a license for use by the content server to distribute the education e-content to the consumption devices. The publishing module may also be configured to transmit the education e-content to the content server, directly, or through the license server.

In various embodiments, the encryption module may be further configured to generate an encryption key for use to encrypt the education e-content. The publishing module may be further configured to transmit a decryption key associated with the encryption key to the license server for inclusion in the license for the content server. In various embodiments, the publishing module may be further configured to transmit meta-data configured to identify a subject and a subject level of the educational e-content to the license server for inclusion in the license for the content server. In various embodiments, the publishing module may be further configured to transmit to the license server business rules configured to govern generation and provision of licenses, by the license server, to the content server.

In various embodiments, a method for licensing education e-content may include receiving, by a license server, from a publisher server associated with one of a number of unassociated publishers the license server is configured to serve, meta-data associated with an education e-content published by the one publisher. Additionally, the method may include receiving, by the license server, an order for the education e-content including consumption device related information that at least facilitates identification of one or more consumption devices to receive the educational e-content. Further, the method may include generating, by the license server, a license including the meta-data and the consumption device related information for use by a content server to distribute the education e-content to fill the order. Still further, the method may include transmitting, by the license server, to the content server, the license.

In various embodiments, receiving from the publisher server may include receiving from the publisher server meta-data identifying a subject and a subject level of the education e-content, and generating a license comprises generating a license including the meta-data identifying the subject and the subject level of the education e-content. Additionally, receiving from the publisher server may further include receiving from the publisher server business rules of the publisher governing distribution and licensing of the education e-content, and generating further comprises generating the license in compliance with the business rules.

In various embodiments, generating a license may include generating a license including a number of copies of the education e-content the content server is permitted to distribute to consumption devices eligible to receive the education e-content. Further, generating a license may include generating a license including an expiration date of the license, for use by consumption devices receiving distribution of the education e-content to regulate consumption of the education e-content. The consumption device related information may include information identifying an education e-content consumption entity which placed the order, enabling the one or more eligible consumption devices to be identified through subject enrollment information in a database associated with the entity.

In various embodiments, the method may further include providing, by the license server, to the publisher server, an encryption key to encrypt the education e-content for distribution, or receiving from the publisher server may further include receiving a decryption key to decrypt an encrypted distribution version of the education e-content. For these embodiments, generating a license may include generating a license that further includes either a decryption key based on the encryption key or the received decryption key. Further, receiving from the publisher server may include receiving from the publisher server a distribution version of the education e-content, while transmitting to the content server may include transmitting to the content server, the distribution version of the education e-content.

In various embodiments, a method for distributing education e-content may include receiving, by a content server, from a license server, a license associated with an education e-content published by one of a plurality unassociated publishers, for use by the content server to distribute the education e-content. The license may include meta-data associated with the education e-content, and consumption device related information that at least facilitates identification of one or more consumption devices eligible to receive and be licensed to consume the education e-content. The content server may be configured to serve the unassociated publishers.

In various embodiments, the meta-data may identify a subject and a subject level of the education e-content, and the consumption device related information may identify an education e-content consumption entity which placed an order for the education e-content, which order is being filled by the license. The method may further include accessing subject enrollment information in a database associated with the entity, using the consumption device related information and the meta-data, to identify the eligible consumption devices.

In various embodiments, the method may further include receiving, by the content server, the education e-content from the license server. Additionally, receiving the education e-content may include receiving an encrypted version of the education e-content from the license server, and receiving a license may include receiving a license further including a decryption key to decrypt the encrypted version of the education e-content. Further, distributing the education e-content may include distributing the encrypted version of the education e-content and the decryption key to the one or more consumption devices.

In various embodiments, the license may further include a number of copies of the education e-content the content server is permitted to distribute to consumption devices eligible to receive the education e-content. The method may further include distributing, by the content device, the education e-content to a number of consumption devices eligible to receive the education e-content, without exceeding the number of copies the content server is permitted to distribute. In various embodiments, the license may further include an expiration date of the license. The method may further include providing, by the content device, the expiration date to the consumption devices to respectively regulate consumption of the education e-content on the consumption devices.

In various embodiments, a non-transitory computer-readable storage medium for consuming education e-content may include instructions, when executed on an education e-content consumption device, cause the consumption device to receive an education e-content, and a license licensing consumption of the education e-content on the consumption device. The license may include meta-data identifying a subject and a subject level of the education e-content. The consumption device may also be caused to confirm the consumption device or a user associated with the consumption device is registered for consumption of the education e-content. The consumption device may conditionally render the education e-content on request, if the consumption device or a user associated with the consumption device is confirmed to be registered for consumption of the education e-content.

In various embodiments, the license may further include an expiration date, and conditionally rendering is further based on the request being made prior to the expiration date. In various embodiments, receive an education e-content may include receive an encrypted version of an education e-content published by one of a plurality of unassociated publishers from a license server configured to serve the unassociated publishers. Further, receive a license may include receive a license including a decryption key for use to decrypt the encrypted version of the education e-content, and conditionally render may include decryption of the encrypted version of the education e-content using the decryption key.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The term “education e-content” as is used herein include all electronic education content, including but not limited to e.g., electronic education content for Mathematics, Arithmetic, Algebra, Geometry, Trigonometry, Calculus, Differential Equation, Statics, Physics, Chemistry, Biology, Science, Statics, Dynamics, Fluid Mechanics, Civil Engineering, Structure, Material Science, Geography, History, Social Studies, Government, Philosophy, Psychology, Microeconomics, Macroeconomics, Finance, Accounting, Marketing, Continuing Education for Lawyers, Accountants, Doctors, Dentist, Architects and other professionals. The “education e-content” may be static or interactive. The “education e-content” can contain lessons, quizes, and/or educational games related to a subject matter.

The term “module” as used herein refers to a hardware and/or software implementation to provide one or more functions. Today, virtually all hardware implementations may be implemented in software, and vice versa. It is a matter of trade off between cost and performance. Software implementations may include implementations in high level languages, such as C or C++, or assembler/machine languages supported by particular processors. Hardware implementations may include Application Specific Integrated Circuits (ASIC) or programmed programmable logics, such as Field Programmable Gate Arrays (FPGA).

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

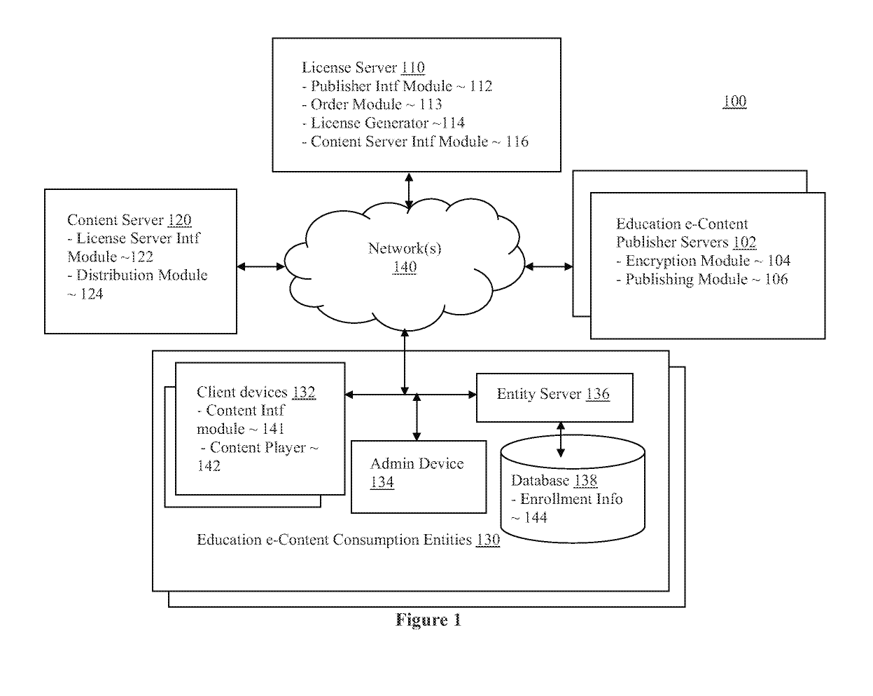

Referring now to FIG. 1, wherein an overview of an education e-content publishing, licensing, distribution and/or consumption arrangement is illustrated. As shown, arrangement 100 may include education e-content publisher servers 102 of a number of education e-content publishers, license server 110, content server 120 and client devices 132 of various education e-content consumption entities 130, coupled to each other via network(s) 140. As will be described in more details below, publisher servers 102, license server 110, content server 120 and client devices 132 are configured to cooperate with each other, directly or indirectly, to enable efficient and secure publishing, licensing, distribution, and/or consumption of various education e-content of the various publishers. Education e-content as described earlier may be multi-media content for a wide range of subject matters of various subject levels.

For the embodiments, the publishers may be unassociated. Each publisher server 102 may serve one or more unassociated publishers, and publish one or more education e-content. License server 110 and/or content server 120 may be configured to serve the various unassociated publishers, to respectively license and distribute education e-content of the publishers. Client devices 132 may be configured to enable users to consume the education e-content. Thus, in the description to follow, client devices 132 may also be referred to as consumption client devices 132 or simply, consumption devices. In addition to client devices 132, an education e-content consumption entity 130 may further include an administration device 134, an entity server 136 and a database 138, coupled to each other, via e.g. a local area network (depicted as arrows with entity 130), as shown. Examples of education e-content consumption entities may include, but are not limited to, school districts or schools, ministries of education, university systems or universities, companies/firms or their divisions/departments.

For the illustrated embodiments, a publisher server 102 may include encryption module 104 and publishing module 106, operationally coupled to each other. Whereas, license server 106 may include publisher interface module 112, order module 113, license generator 114 and content server interface module 116, operationally coupled to each other, and content server 120 may include license server interface module 122 and distribution module 124, operationally coupled to each other. A client device 132 may include content interface module 141, and content player 142, also may be referred to as media player 142. Administration device 134 may include a browser (not shown). Entity server 136 may include a web server (not shown). Database 138 may include various data of an education e-content consumption entity 130, e.g. enrollment information of various users associated with client devices 132. These elements and their interactions with each other will be described in more details in turn below.

Focusing now first on a publisher server 102, for the embodiments, encryption module 104 may be configured to encrypt an education e-content of a publisher to generate an encrypted distribution version of the education e-content to enable the education e-content to be distributed in a protected manner. For these embodiments, consumption of the education e-content would require a content player 142 having access to the corresponding decryption key. In various embodiments, encryption module 104 may be further configured to generate the encryption key for use to encrypt an education e-content. In other embodiments, the encryption key for use to encrypt an education e-content may be provided by, and received from license server 110. In alternate embodiments, the present disclosure may be practiced without encrypting an education e-content, distributing the education e-content unencrypted in plain text.

For the embodiments, publishing module 106 may be configured to distribute an education e-content, encrypted or unencrypted. In various embodiments, publishing module 106 may be configured to distribute an education e-content to a client device 132 directly, or via content server 120, with or without going through license server 110.

Additionally, in various embodiments, publishing module 106 may be configured to provide meta-data associated with the education e-content to license server 110 for use by the license server 110 to generate a license to license the education e-content. The meta-data may include information identifying a subject of the education e-content, and/or a subject level of the education e-content, e.g. a grade level, a beginner level, an intermediate level or an advanced level, and so forth. In various embodiments, publishing module 106 may be further configured to provide business rules to license server 110 for use by license server 110 to govern its generation of licenses and licensing the education e-content. Examples of business rules may include rules that specify the various rights associated with an education e-content may be licensed, e.g., reading rights, printing rights, copying rights, and so forth. For the embodiments where the encrypted distribution version of an education e-content is generated using an encryption key generated by encryption module 104, publishing module 106 may be further configured to provide the corresponding decryption key to a client device 132 provided with the encrypted distribution version directly, or via content server 120, with or without going through license server 110.

Turning now to license server 110, publisher interface module 112 may be configured to interact with the various publishing servers 102 of the various unassociated publishers. In particular, publisher interface module 112 may be configured to receive from a publisher server 102, the earlier described meta-data, business rules, the distribution version, and/or the decryption key associated with an education e-content, license server 110 is to license. For embodiments, where license server 110 provides a publisher server 102 with an encryption key to use to encrypt the distribution version of an education e-content, publisher interface module 112 may be further configured to securely provide the encryption key to a publisher server 102 for use to encrypt an education e-content.

In various embodiments, order module 113 may be configured for accepting an order, from a consumption device 132 or an administration device 134 of a consumption entity 130, for one or more copies of an education e-content of a publisher. For examples, a ministry of education may place an order for 5,000 copies of an arithmetic course published by one publisher for its 5^{th} grade students, or a law firm may place an order for 100 copies of an Ethics Self-Study published by another publisher. Order module 113 may be configured to offer a web interface to enable an administrator of an entity 130 to place an order, using e.g., a browser on administration device 134. The order may include identification information of the education e-content consumption entity 130 and the number of copies ordered.

For embodiments where an education e-content consumption 130 includes database 138 with enrollment information 144, and entity server 136 to facilitate access of the enrollment information, the identification information of the education e-content consumption entity 130 may be configured to enable access of enrollment information 144. Through usage of the meta-data that identifies the subject (and subject level) of an education e-content, client devices 132 eligible to receive the ordered education e-content may be identified. For example, a uniform resource locator (URL) of database 138 of a school district may be inferred from the name of the school district placing the order. And through the subject and subject level information, such as, Math for 5^{th} grade, client device 132s associated with all 5th graders registered for the Math class may be identified.

In alternate embodiments, the present disclosure may be practiced with education e-content consumption entities 130 without having been configured with database 138 and entity server 136. For these embodiments, the order may explicitly identify client devices 132 to receive the education e-content. In still other embodiments, the present disclosure may be practiced with client devices 132 that are not members of a large education e-content consumption entity 130. These client devices 132 may place the orders through order module 113 of license server 110 directly, and explicitly identify themselves as client devices to receive the ordered education e-content.

Continuing with the illustrated embodiments, license generator 114 may be configured to generate a license to license an education e-content to fill an order, in response to receipt of the order. In various embodiments, the generated license may be provided to content server 120 for use to govern its distribution of the corresponding education e-content. In various embodiments, a license may include meta-data that describes the education e-content being licensed. As described earlier, the meta-data may identify a subject and/or a subject level of the corresponding education e-content. A license may further include consumption device related information that at least facilitates identification of the consumption devices 132 eligible to receive the corresponding education e-content. In other words, as described earlier, consumption device related information may explicitly identify client devices 132 eligible to receive the particular education e-content, or indirectly identify them, e.g. by providing information that enable their identification through access of enrollment information 144 in database 138, using e.g., subject and/or subject level meta-data of the particular education e-content.

In various embodiments, a license may further include a number of copies of the education e-content ordered. The number of copies information may be used to set a limit of the number of copies of the education e-content may be distributed by content server 120. A license may also include an expiration date denoting an end day of the license. The expiration date may be later used by content players 142 of client devices 132 to regulate consumption of the education e-content, preventing any further consumption after the expiration date.

In various embodiments, content server interface module 116 may be configured to provide the license, including meta-data, consumption device related information, and/or decryption key, to content server 120. For embodiments where the distribution version of an education e-content is to be provided to content server 120 by license server 110, content server interface module 116 may be further configured to provide content server 120 with the distribution version of an education e-content.

Turning now to content server 120, license server interface module 122 may be configured to interact with license server 110, in particular, content server interface module 116. License server interface module 122 may be configured to receive a license and/or the distribution version of the corresponding education e-content from license server 110.

In various embodiments, distribution module 124 may be configured to distribute an education e-content to eligible client devices 132, in accordance with the specification of the corresponding license. In particular, distribution module 124 may be configured to distribute an education e-content to eligible client devices 132 as long as the number of distributed copies has not exceed the distribution bound of the license, and the license has not expired. For embodiments where content server 120 has been provided with a distribution version of an education e-content, distribution module 124 may provide the distribution version to an eligible client device 132 directly. In alternate embodiments, content server 120 may be configured to provide to an eligible client device 132 a location where the eligible client device 132 may retrieve a copy of the education e-content, e.g., publisher server 102 or a proxy server of either publisher server 102, license server 110 or content server 120. In various embodiments, distribution module 124 may be further configured to use the consumption device related information and/or meta-data in a license to identify client devices 132 eligible to receive the corresponding education e-content.

Turning now to education e-content consumption entities 130, content interface module 141 may be configured to receive from content server 120 (or license server 110) the license for the e-education content. Content interface module 141 may be also configured to receive from content server 120 (or licenser server 110 or publisher server 102), the e-education content. Except for the teachings of the present disclosure, content player 142 of a client device 132 may be any one of a wide range of multi-media players known in the art. Similarly, except for their usage, browser (not shown) of administration device 134, and web server (not shown) of entity server 136 may also be any one of a wide range of these elements known in the art, e.g., Internet Explorer available from Microsoft Corp of Redmond, Wash., and Apache Web server available from Apache HTTP Server Project. Enrollment information 144 of database 138 may include information on classes or courses the various users/students are registered to take/study, identifications of the users/students, identifications of the users/students' client devices 132, identifications of the users/students' grade/organization level, identifications of the users/students' teachers, supervisors/managers, and so forth.

In addition to client devices 132, a consumption entity may include an administration device 134 configured to administer education e-content consumption with entity 130. Administration may include placing an order for an education e-content on behalf of a consumption entity 130. Further, consumption entity 130 may include a database 138 with enrollment information, and entity server 136 configured to facilitate access of database 138, such as classes or courses the various users/students are registered to take/study, identifications of the users/students, or identifications of the users/students' client devices 132, and so forth.

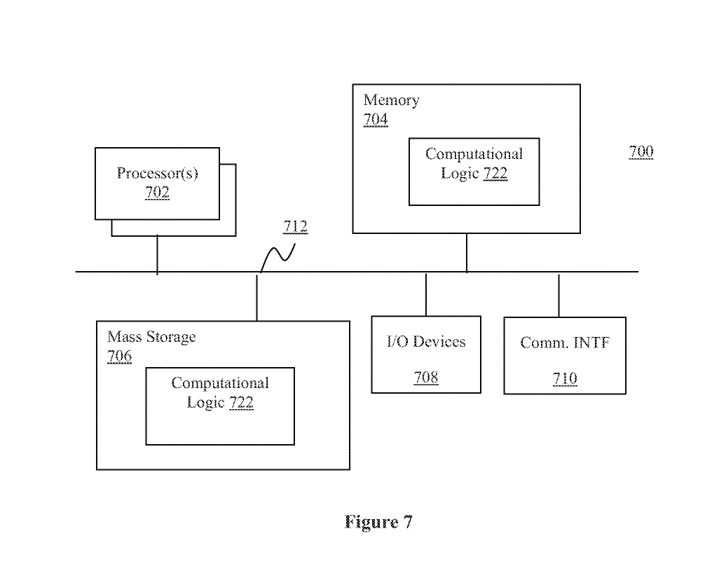

Except for implementations to practice aspects of the present disclosure, publisher server 102, license server 110, content server 120, client devices 132, administration device 134 and entity server 136 may be anyone of a number of laptop, tablet, desktop and servers known in the art. For examples, laptops and/or tablets may be those available from Apple Computer of Cupertino, Calif. Desktop and servers may be those available from Hewlett Packard of Palo Alto, Calif. An example computer system suitable for use as a publisher server 102, license server 110, content server 120, client devices 132, administration device 134 or entity server 136 will be later described with references to FIG. 7. In particular, client devices 132 may be Classmate PCs powered by Intel of Santa Clara, Calif., available from a number of Original Equipment Manufacturers (OEM). Network(s) 140 may include one or more private and/or public networks, including e.g., the Internet. The one or more private/public networks may be wired and/or wireless, local and/or wide area.

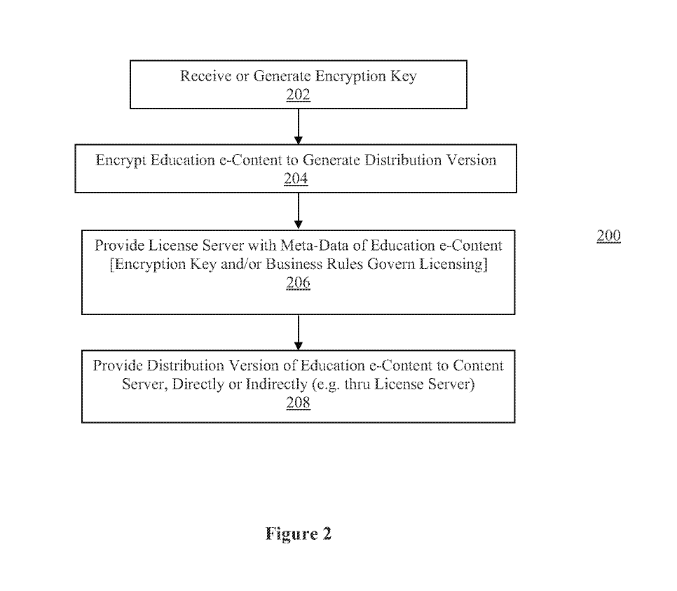

Referring now to FIG. 2, wherein a publishing method suitable for practice by a publisher server 102, in accordance with various embodiments, is illustrated. As shown, publishing method 200 may start at block 200, with a publisher server 102, generating or receiving from a license server 110, an encryption key for use to encrypt an education e-content to generate a distribution version of the education e-content. From block 202, method 200 may proceed to block 204, where a publisher server 102 may encrypt an education e-content to generate a distribution version of the education e-content. From block 204, method 200 may proceed to block 206, where a publisher server 102 may provide to license server 110 meta-data associated with an education e-content, an encryption key, if generated by Publisher, and/or business rules for use by license server 110 to govern licensing of the education e-content. From block 206, method 200 may proceed to block 208, where a publisher server 102 may provide the distribution version of the education e-content to a client device 132, directly or indirectly, or via content server 120, with or without going through license server 110.

In alternate embodiments, operations performed at block 202-208 may be performed in different order. For example, operation(s) in block 206 may be performed before operations performed in blocks 204 and 206. Further, method 200 may be practiced with more or less operations, as well as modified and/or derivative versions of the described operations.

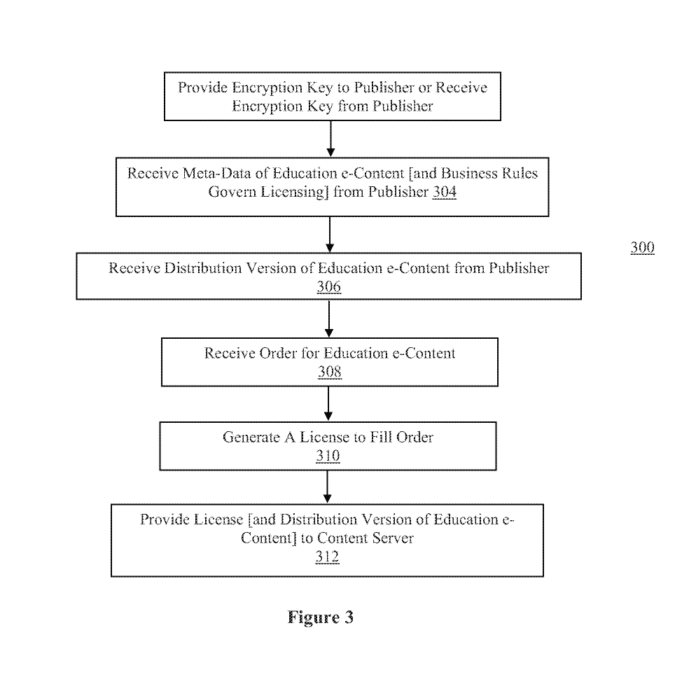

Referring now to FIG. 3, wherein a licensing method suitable for practice by license server 110, in accordance with various embodiments is illustrated. As shown, licensing method 300 may start at block 302, with license server 110 providing to a publisher server 102, an encryption key for use by the publisher server 102 to encrypt an education e-content to generate a distribution version of the education e-content. Alternatively, at block 302, license server 110 may receive an encryption key from the publisher server 102. From block 302, method 300 may proceed to block 304, where license server 110 may receive from a publisher server 102, meta-data associated with an education e-content, and/or business rules for use to govern licensing of the education e-content. From block 304, method 300 may proceed to block 306, where license server 110 may receive from a publisher server 102, a distribution version of an education e-content.

From block 306, method 300 may proceed to block 308, where license server 110 may receive from an order for one or more copies of an education e-content. From block 308, method 300 may proceed to block 310, where license server 110 may generate a license to license the ordered number of copies of the ordered education e-content, if the ordered number is available. For example, if license server 110 has been informed by a publisher server 102 that the license server 110 is authorized to fill orders up to 1,000 copies, and the license server 110 received an order for 200 copies after having licensed 800 copies, the license server 110 may proceed to issue a license for 200 copies to fill the order. On the other hand, if the license server 110 received an order for 300 copies after having licensed 800 copies, the license server 110 may either proceed to issue a license for 200 copies to partially fill the order or decline the order.

From block 310, method 300 may proceed to block 312, where license server 110 may provide to content server 120, the license, and/or a distribution version of the education e-content. In various embodiments, license server 110 may provide to content server 120, a distribution version of the education e-content only once. Once content server 120 has the distribution version, license server 110 needs not further provide the distribution version again for subsequent licenses.

In alternate embodiments, operations performed at block 302-312 may be performed in different order. For examples, operations performed in block 310 may be performed in advance of the operations performed at blocks 304 and 306, and operations performed at block 306 may be performed after the operations performed at blocks 308 and 310. Further, method 300 may be practiced with more or less operations, as well as modified and/or derivative versions of the described operations.

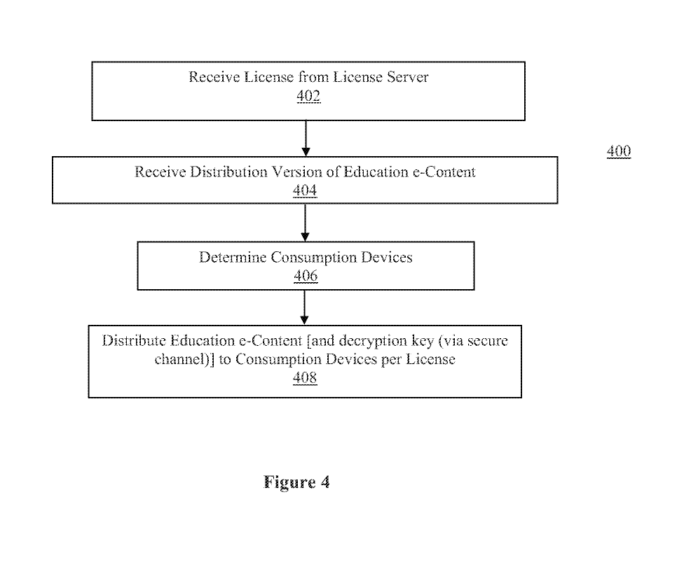

Referring now to FIG. 4, wherein a distribution method suitable for practice by content server 120, in accordance with various embodiments is illustrated. As shown, distribution method 400 may start at block 402, with content server 120 receiving from license server 110, a license to license an education e-content. As described earlier, the license may include meta-data, describing e.g., subject and subject level of the corresponding education e-content, consumption devices related information, number of licenses licensed, license expiration date, decryption key, and so forth.

From block 402, method 400 may proceed to block 404, where content server 120 may receive from license server 110, a distribution version of the education e-content. From block 404, method 400 may proceed to block 406, where content server 120 may proceed to determine the consumption client devices 132, using the consumption devices related information, and/or meta-data in the license. For example, as described earlier, content server 120 may determine/identify the consumption client devices 132 by accessing enrollment information 144 of database 138 of a consumption entity 130, using e.g., meta-data describing subject and subject level of the education e-content.

From block 406, method 400 may proceed to block 408, where content server 120 may proceed to distribute the education e-content and/or the decryption key via a secure channel to the consumption client devices 132, as long as the number of copies distributed does not exceed the number of copies limit in the license. In various embodiments, content server 120 may further provide the decryption key to the consumption client devices 132, if the distribution version of the education e-content is encrypted. Content server 120 may further provide the expiration date to the consumption client devices 132, for media players 142 on the consumption client devices 132 to regulate consumption of the education content, and not allowing any further consumption after the expiration date.

In alternate embodiments, operations performed at block 402-408 may be performed in different order. Performance of the operations of blocks 404 and 406 may be swapped. Further, method 400 may be practiced with more or less operations, as well as modified and/or derivative versions of the described operations.

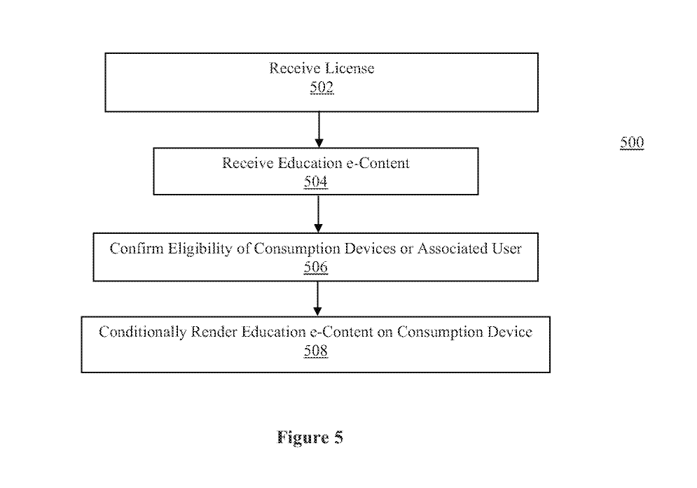

Referring now to FIG. 5, wherein a consumption method suitable for use by a consumption client device 132, in accordance with various embodiments is illustrated. As shown, method 500 may start at block 502, where a consumption client device 132 may receive a license for an education e-content. In various embodiments, client device 132 may additionally be configured to extract the decryption key and store it in a protected storage location of client device 132. In alternate embodiments, the decryption key may be received by client device 132 via a secure communication channel. From block 502, method 500 may proceed to block 504, where the consumption client device 132 may receive a distribution version of the education e-content. From block 504, method 500 may proceed to block 506, where on invocation, media player 142 of the consumption client device 132 may confirm the consumption client device 132 is an eligible device to facilitate consumption of the education e-content. In various embodiments, media player 142 may confirm eligibility by accessing the earlier described enrollment information 144 of the consumption entity 130 in like manner as earlier described.

From block 506, method 500 may proceed to block 508, where on confirmation of eligibility, media player 142 proceed to render the education e-content and facilitate their consumption by a user of consumption client device 132. In various embodiments, media player 142, on failure to confirm eligibility (e.g., a client device associated with a 5^{th} grade student trying to consume an education e-content for 4^{th} grade students) or on detecting the education e-content is a pirated copy (e.g., not having the necessary decryption key) or being consumed in an unauthorized manner (e.g., copies being made without copying rights), media player 142 may return an error message.

In alternate embodiments, operations performed at block 502-508 may be performed in different order. For examples, the operations performed at blocks 504 and 506 may be swapped. Further, method 500 may be practiced with more or less operations, as well as modified and/or derivative versions of the described operations.

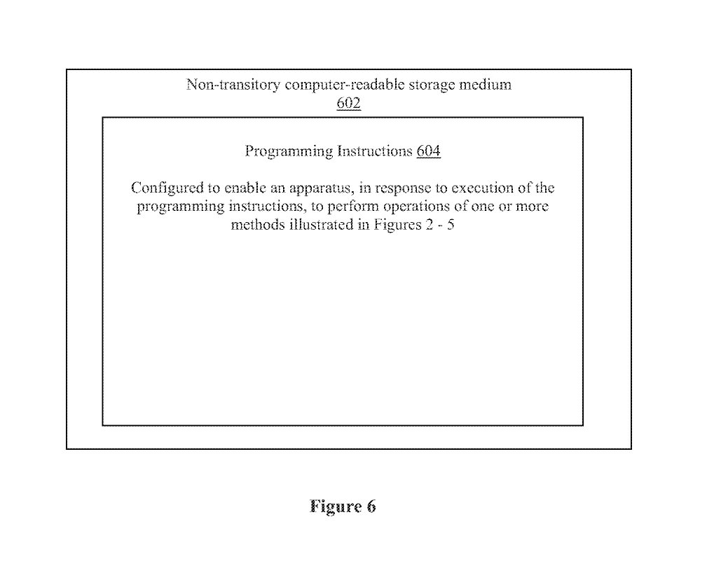

FIG. 6 illustrates a non-transitory computer-readable storage medium, in accordance with various embodiments of the present disclosure. As illustrated, non-transitory computer-readable storage medium 602 may include a number of programming instructions 604. Programming instructions 604 may be configured to enable an apparatus, in response to execution of the programming instructions by the apparatus, to perform operations of earlier described methods 200, 300, 400 and/or 500.

FIG. 7 illustrates an example computer system suitable for use as a computing node or the control node in accordance with various embodiments of the present disclosure. As shown, computing system 700 includes a number of processors or processor cores 702, and system memory 704. For the purpose of this application, including the claims, the terms “processor” and “processor cores” may be considered synonymous, unless the context clearly requires otherwise. Additionally, computing system 700 includes mass storage devices 706 (such as diskette, hard drive, compact disc read only memory (CDROM) and so forth), input/output devices 708 (such as display, keyboard, cursor control and so forth) and communication interfaces 710 (such as network interface cards, modems and so forth). The elements are coupled to each other via system bus 712, which represents one or more buses. In the case of multiple buses, they are bridged by one or more bus bridges (not shown).

Each of these elements performs its conventional functions known in the art. In particular, system memory 704 and mass storage 706 may be employed to store a working copy and a permanent copy of the programming instructions implementing methods 200, 300, 400 and/or 500, or portions thereof, herein collectively denoted as, computational logic 722. The various components may be implemented by assembler instructions supported by processor(s) 702 or high-level languages, such as, for example, C, that can be compiled into such instructions.

The permanent copy of the programming instructions may be placed into permanent storage 706 in the factory, or in the field, through, for example, a distribution medium (not shown), such as a compact disc (CD), or through communication interface 710 (from a distribution server (not shown)). That is, one or more distribution media having computational logic 722 may be employed to distribute computational logic 722 and program various computing devices to enable the computing devices to practice methods 200, 300, 400 and/or 500.

The constitution of these elements 702-712 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

1. A license server, comprising:
a publisher interface module configured to receive from a publisher server associated with one of a plurality of unassociated publishers the license server is configured to serve, meta-data associated with an education e-content published by the one publisher;
an order module configured to receive an order for the education e-content including consumption device related information that at least facilitates identification of one or more consumption devices to receive the educational e-content;
a license generator coupled to the publisher interface module and the order module, and configured to generate a license including the meta-data and the consumption device related information for use by a content server to distribute the education e-content to fill the order; and
a content server module coupled to the license generator, and configured to transmit to the content server, the license.

2. The license server of claim 1, wherein the publisher interface module is configured to receive from the publisher server meta-data identifying a subject and a subject level of the education e-content, and the license generator is configured to generate a license including the meta-data identifying the subject and the subject level of the education e-content.

3. The license server of claim 1, wherein the publisher interface module is configured to receive from the publisher server business rules of the publisher governing distribution and licensing of the education e-content, and the license generator is configured to generate the license in compliance with the business rules.

4. The licenser server of claim 1, wherein the license generator is configured to generate a license including a number of copies of the education e-content the content server is permitted to distribute to consumption devices eligible to receive the education e-content.

5. The license server of claim 1, wherein the license generator is configured to generate a license including an expiration date of the license, for use by consumption devices receiving distribution of the education e-content to regulate consumption of the education e-content.

6. The license server of claim 1, wherein the consumption device related information includes information identifying an education e-content consumption entity which placed the order, enabling the one or more eligible consumption devices to be identified through subject enrollment information in a database associated with the entity.

7. The license server of claim 1, wherein the publisher interface module is either further configured to provide to the publisher server an encryption key to encrypt the education e-content for distribution, or configured to receive from the publisher server a decryption key to decrypt an encrypted distribution version of the education e-content.

8. (canceled)

9. The license server of claim 1, wherein the publisher interface module is either further configured to receive from the publisher server a distribution version of the education e-content, and the content server interface module is further configured to transmit to the content server, the distribution version of the education e-content.

10. At least one non-transitory computer-readable storage medium having instructions stored therein, the instructions when executed on a license server, cause the license server to:
receive from a publisher server associated with one of a plurality of unassociated publishers the license server is configured to serve, meta-data associated with an education e-content published by the one publisher;
receive an order for the education e-content including consumption device related information that at least facilitates identification of one or more consumption devices to receive the educational e-content;
generate a license including the meta-data and the consumption device related information for use by a content server to distribute the education e-content to fill the order; and
transmit to the content server, the license.

11. The storage medium 10, wherein the instructions, when executed on the license server, further enables the license server to receive from the publisher server meta-data identifying a subject and a subject level of the education e-content, and to generate the license including the meta-data identifying the subject and the subject level of the education e-content.

12. The storage medium of claim 10, wherein the instructions, when executed on the license server, further enables the license server to receive from the publisher server business rules of the publisher governing distribution and licensing of the education e-content, and to generate the license in compliance with the business rules.

13. The storage medium of claim 10, wherein the instructions, when executed on the license server, enables the license server to generate the license including a number of copies of the education e-content the content server is permitted to distribute to consumption devices eligible to receive the education e-content.

14. The storage medium of claim 10, wherein the instructions, when executed on the license server, further enables the license server to generate the license including an expiration date of the license, for use by consumption devices receiving distribution of the education e-content to regulate consumption of the education e-content.

15. The storage medium of claim 10, wherein the consumption device related information includes information identifying an education e-content consumption entity which placed the order, enabling the one or more eligible consumption devices to be identified through subject enrollment information in a database associated with the entity.

16. The storage of claim 10, wherein the instructions, when executed on the license server, further enables the license server to either provide to the publisher server, an encryption key to encrypt the education e-content for distribution, or receive from the publisher server a decryption key to decrypt an encrypted distribution version of the education e-content.

17. (canceled)

18. The storage of claim 10, wherein the instructions, when executed on the license server, further enables the license server to receive from the publisher server a distribution version of the education e-content, and to transmit to the content server, the distribution version of the education e-content.

19. An apparatus comprising:
one or more processors;
an encryption module configured to be operated by one of the one or more processors to generate an encrypted version of an education e-content of one of a plurality of unassociated publishers for distribution to consumption devices through a content server configured to serve the plurality of unassociated publishers; and
a publishing module configured to be operated by one of the one or more processors to publish the education e-content including
transmission of meta-data associated with the educational e-content to a license server configured to serve the plurality of unassociated publishers, for use by the license server to generate a license for use by the content server to distribute the education e-content to the consumption devices; and
transmission of the education e-content to the content server, directly, or through the license server.

20. The apparatus of claim 19, wherein the encryption module is further configured to generate an encryption key for use to encrypt the education e-content, and the publishing module is further configured to transmit a decryption key associated with the encryption key to the license server for inclusion in the license for the content server.

21. The apparatus of claim 19, wherein the publishing module is further configured to transmit meta-data configured to identify a subject and a subject level of the educational e-content to the license server for inclusion in the license for the content server.

22. The apparatus of claim 19, wherein the publishing module is further configured to transmit to the license server business rules configured to govern generation and provision of licenses, by the license server, to the content server.

23. At least one non-transitory computer-readable storage medium having instructions stored therein, the instructions when executed on a publisher server of one of a plurality of unassociated publishers, cause the publisher server to:
generate an encrypted version of an education e-content of the publisher for distribution to consumption devices through a content server configured to serve the plurality of unassociated publishers; and
publish the education e-content including
transmission of meta-data associated with the educational e-content to a license server configured to serve the plurality of unassociated publishers, for use by the license server to generate a license for use by the content server to distribute the education e-content to the consumption devices; and
transmission of the education e-content to the content server, directly, or through the license server.

24. The storage medium of claim 23, wherein the instructions when executed on the publisher server, further causes the publisher server to generate an encryption key for use to encrypt the education e-content, and to transmit a decryption key associated with the encryption key to the license server for inclusion in the license for the content server.

25. The storage medium of claim 23, wherein the instructions when executed on the publisher server, further causes the publisher server to transmit meta-data configured to identify a subject and a subject level of the educational e-content to the license server for inclusion in the license for the content server.

26. The storage medium of claim 23, wherein the instructions when executed on the publisher server, further causes the publisher server to transmit to the license server business rules configured to govern generation and provision of licenses, by the license server, to the content server.

27. A content server comprising:
a license server interface module configured to receive from a license server, a license associated with an education e-content published by one of a plurality unassociated publishers, for use by the content server to distribute the education e-content, the license including meta-data associated with the education e-content, and consumption device related information that at least facilitates identification of one or more consumption devices eligible to receive and be licensed to consume the education e-content, wherein the content server is configured to serve the plurality of unassociated publishers; and
a distribution module configured to the license server interface module, and configured to distribute the education e-content to the one or more eligible consumption devices, based on the license.

28. The content server of claim 27, wherein the meta-data identifies a subject and a subject level of the education e-content, and the consumption device related information identifies an education e-content consumption entity which placed an order for the education e-content, which order is being filled by the license, wherein the distribution module is further configured to access subject enrollment information in a database associated with the entity, using the consumption device related information and the meta-data, to identify the eligible consumption devices.

29. The content server of claim 27, either the license server interface module or the distribution module is further configured to receive the education e-content from the license server.

30. The content server of claim 29, wherein
the license server interface module is further configured to receive an encrypted version of the education e-content from the license server, and to receive, from the license server, a license including a decryption key to decrypt the encrypted version of the education e-content; and
the distribution module is further configured to distribute the encrypted version of the education e-content and the decryption key to the one or more consumption devices.

31. (canceled)

32. (canceled)

33. At least one non-transitory computer-readable storage medium having instructions stored therein, the instructions when executed on a content server, cause the content server to:
receive, from a license server, a license associated with an education e-content published by one of a plurality unassociated publishers, for use by the content server to distribute the education e-content, the license including meta-data associated with the education e-content, and consumption device related information that at least facilitates identification of one or more consumption devices eligible to receive and be licensed to consume the education e-content, wherein the content server is configured to serve the plurality of unassociated publishers; and
distribute the education e-content to the one or more eligible consumption devices, based on the license.

34. The storage medium of claim 33, wherein the meta-data identifies a subject and a subject level of the education e-content, and the consumption device related information identifies an education e-content consumption entity which placed an order for the education e-content, which order is being filled by the license, wherein the instructions when executed on the content server, further cause the content server to access subject enrollment information in a database associated with the entity, use the consumption device related information and the meta-data, to identify the eligible consumption devices.

35. The storage medium of claim 33, wherein the instructions when executed on a content server, further cause the content server to receive the education e-content from the license server.

36. (canceled)

37. (canceled)

38. (canceled)

39. At least one non-transitory computer-readable storage medium having instructions stored therein, the instructions when executed on an education e-content consumption device, cause the consumption device to:
receive an education e-content;
receive a license licensing consumption of the education e-content on the consumption device, wherein the license includes meta-data identifying a subject and a subject level of the education e-content;
confirm the consumption device or a user associated with the consumption device is registered for consumption of the education e-content; and
conditionally render the education e-content on request, if the consumption device or a user associated with the consumption device is confirmed to be registered for consumption of the education e-content.

40. The storage medium of claim 39, wherein the license further comprises an expiration date, and conditionally rendering is further based on the request being made prior to the expiration date.

41. The storage medium of claim 39, wherein receive an education e-content comprises receive an encrypted version of an education e-content published by one of a plurality of unassociated publishers from a license server configured to serve the plurality of unassociated publishers, receive a license comprises receive a license including a decryption key for use to decrypt the encrypted version of the education e-content, and conditionally render comprises decrypt the encrypted version of the education e-content using the decryption key.

42. A client device comprising:
a content interface module configured to receive an education e-content, and a license licensing consumption of the education e-content on the consumption device, wherein the license includes meta-data identifying a subject and a subject level of the education e-content; and
a content player coupled to the content interface module, and configured to confirm the consumption device or a user associated with the consumption device is registered for consumption of the education e-content, and to conditionally render the education e-content on request, if the consumption device or a user associated with the consumption device is confirmed to be registered for consumption of the education e-content.

43. The client device of claim 42, wherein the license further comprises an expiration date, and the content player is configured to conditionally render, based further on the request being made prior to the expiration date.

44. The client device of claim 42, wherein the content interface module is further configured to receive an encrypted version of the education e-content published, and the license includes a decryption key for use to decrypt the encrypted version of the education e-content, and wherein the content player is further configured to decrypt the encrypted version of the education e-content using the decryption key.
